(19) United States
(12) Patent Application Publication
(10) Pub. No.: US 2008/0235198 A1
(43) Pub. Date: Sep. 25, 2008

(54) Translation Service for a System with a Content Directory Service

(75) Inventors: Bruce Duncan, Reading (GB); Dale R. Heron, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/573,552

(22) PCT Filed: Sep. 27, 2004
(86) PCT No.: PCT/IB04/51876

§ 371 Date: Mar. 27, 2006

(30) Foreign Application Priority Data
Sep. 30, 2003 (GB) 0322792.3

(51) Int. Cl. G06F 7/06; G06F 17/30

(52) U.S. Cl. 707/4; 707/E17.017

(57) ABSTRACT

A system includes a device (MS-a) which stores media content information using a form of Content Directory Service (CDS) and querying devices (CP-a) which make queries for media content information. An entity (70) provides a translation service for querying devices (CP-a). Entity (70) translates a query (302) from the querying device (CP-a) into an optimised query using previously acquired knowledge of the CDS of the device (MS-a). This can reduce the time taken to extract the required information from a serving device. The knowledge of the CDS can include the structure, scope, metadata availability, content distribution, search facilities and querying performance offered by the Content Directory Service (CDS) of the serving device (MS-a). The system can be based on Universal Plug and Play (UPnP).

This invention relates to systems which use a Content Directory Service (CDS) to store media content information, such as systems which conform to the Universal Plug and Play (UPnP) architecture.

There is an ever increasing use of digital storage devices to store media content. The media content can range from simple text files to multi-media content such as audio, pre-recorded or user-recorded video, broadcast digital audio (e.g. Internet radio), broadcast digital video or digital images (e.g. digital photos.)

Universal Plug and Play (UPnP) is a communications protocol which allows electronic devices produced by different manufacturers to operate with one another. UPnP is designed to support zero-configuration, “invisible” networking, with automatic discovery of new devices. This means a device can dynamically join a network, obtain an IP address, convey its capabilities, and learn about the presence and capabilities of other devices. A further development of UPnP is the UPnP Audio-Visual (AV) Architecture which describes extensions of the UPnP architecture relevant to Audio-Visual devices. The UPnP AV Architecture defines a Media Server, a Media Renderer and a Control Point.

Many devices within a UPnP compliant network, such as a UPnP home network, contain various types of content that other devices in the network would like to access (e.g. music, videos, still images). As an example, a Media Server device might contain audio, video, and still-image libraries. In order for the user to enjoy this content, the user must be able to browse the objects stored on the Media Server, select a specific one, and cause it to be played on an appropriate rendering device (e.g. an audio player for music objects, a TV for video content, an Electronic Picture Frame for still-images). For maximum convenience, it is desirable to allow the user to initiate these operations from a variety of user interface (UI) devices. In most cases, these UI devices will either be a UI built into the rendering device, or it will be a stand-alone UI device such as a remote control unit, wireless personal digital assistant (PDA) or tablet. It is desirable that a user can access the content without having to interact directly with the device containing the content.

One of the primary parts of the UPnP AV Architecture is the Content Directory Service (CDS). The CDS provides a set of features which allow UPnP Control Point (CP) devices to access the content stored on Media Server (MS) devices. The current publicly available description of CDS is the “Content Directory Service Template Version 1.01” for Universal Plug and Play Version 1.0, Jun. 25, 2002. The Content Directory Service allows clients (e.g. UI devices) to locate individual objects (e.g. songs, movies, pictures) that the server device is capable of providing. For example, this service can be used to provide a list of songs stored on an MP3 player, a list of still-images comprising various slide-shows, a list of movies stored in a DVD Jukebox, a list of TV shows currently being broadcast, a list of songs stored in a CD Jukebox, a list of programs stored on a PVR (Personal Video Recorder) device. Nearly any type of content can be listed via the CDS and multiple types of content (e.g. MP3, MPEG2, JPEG) can be listed together by the CDS.

Content is stored in a hierarchical structure of UPnP container objects, each container having a collection of objects stored within them. Each object includes media content information and a media content locator such as a Uniform Resource Identifier (URI). Although the UPnP AV Working Committee has issued a set of class definitions (see Appendix C of the “Content Directory Service Template Version 1.01” for Universal Plug and Play Version 1.0, Jun. 25, 2002), UPnP does not require a Media Server's CDS to be arranged in a particular way and so the way in which containers and objects are arranged is decided by each vendor or user. Consequently, each CDS can have a unique structure and individual objects within the structure may be labelled with different combinations of descriptive metadata. Additionally, UPnP defines two mechanisms by which a CDS can be inspected by a querying device: a “Browse” mechanism by which a querying device can browse through the CDS structure and a more useful “Search” mechanism by which a querying device can request a CDS to return items meeting specified search terms. However, the “Search” mechanism is optional and it is possible that the CDS hosted by a Media Server does not implement UPnP's optional “Search” functionality but instead requires the CP to “Browse” its hierarchy on a container-by-container basis.

In view of the above, situations can arise where the storage structure exposed by the CDS is not a good fit to the content structure that the CP wishes to represent to the user, or the content retrieval methods that the CP wishes to provide. Under these circumstances, the CP will find it laborious to extract the information that it's user interface (UI) requires from the CDS structure. This has the disadvantage of extending the response time between a user making a query at a UI and the UI responding with an answer to the query. This degrades the user's experience of using the system.

Accordingly, the present invention seeks to provide an improved way of accessing a content directory service.

A first aspect of the present invention provides a method of providing media content information in a system which uses a Content Directory Service (CDS) to store the media content information, comprising:

receiving, from a querying device, a query for media content information from the CDS of a serving device;

using knowledge of the CDS of the serving device, which has been previously acquired, to translate the query into an optimised query;

querying the CDS of the serving device using the optimised query; and,

providing a response to the querying device.

Using knowledge of the CDS to derive an optimised query can reduce the time taken to extract the required information from a serving device.

The knowledge of a CDS can include the structure, scope, metadata availability, content distribution, search facilities and querying performance offered by the Content Directory Service (CDS) of a particular serving device, or plurality of serving devices.

The method can be performed by a device, either for internal use by that device or as a service which can be used by other devices in the system. Performing the method as a service for other devices reduces the amount of processing required by the querying device, which is a particular advantage when the querying device has limited processing resources or a network connection with limited bandwidth or poor quality, as in the case of a portable device.

The method can be hosted by any device with processing and storage resources (such as a UPnP device of the Media Server or Control Point type.) The method can be hosted by a device which provides another service to devices on the network, and is particularly suited for hosting by any device which holds knowledge about storage devices on the network.

As the knowledge of the CDS relates to features such as structure, rather than specific content, the requirements for maintaining the knowledge up-to-date are not onerous. Most updates that occur to a CDS are likely to be the addition or removal of items, rather than significant changes to structure.

Another aspect of the invention provides apparatus for performing the method. The functionality described here can be implemented in software, hardware or a combination of these, Accordingly, a further aspect of the invention provides software for performing the method. The software may be stored on an electronic memory device, hard disk, optical disk or other machine-readable storage medium and will be executed by a suitable processing device on the host device. The software may be delivered as a computer program product on a machine-readable carrier or it may be downloaded directly to the host device via a network connection. It will be appreciated that the software may be installed at any point during the life of the host device.

The term ‘Content Directory Service’ (CDS) is intended to include the CDS used in UPnP systems, but it is not to be taken as limited to just UPnP systems. It can include any CDS-like storage system for media content information which has a hierarchical structure that is loosely defined and thus unpredictable and difficult for querying devices to extract required information from.

Embodiments of the present invention will now be described, by way of example only, with reference to the accompanying drawings, in which:—

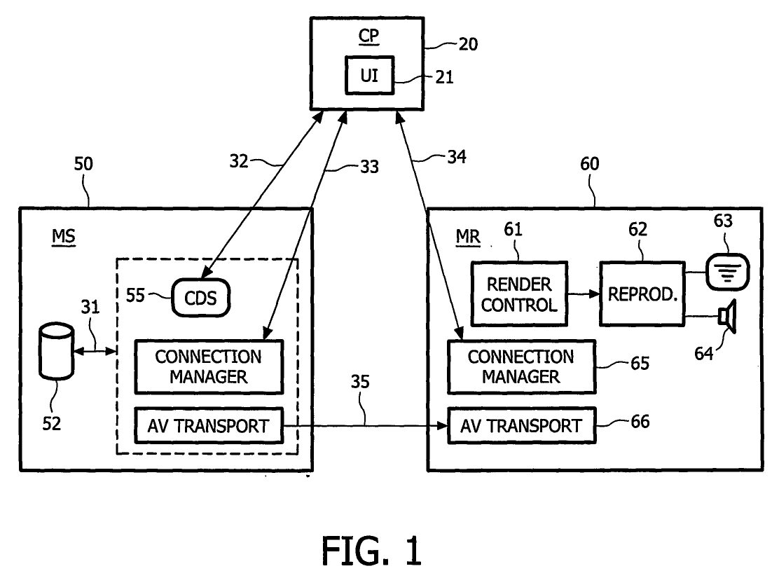

FIG. 1 shows the main components of a UPnP system;

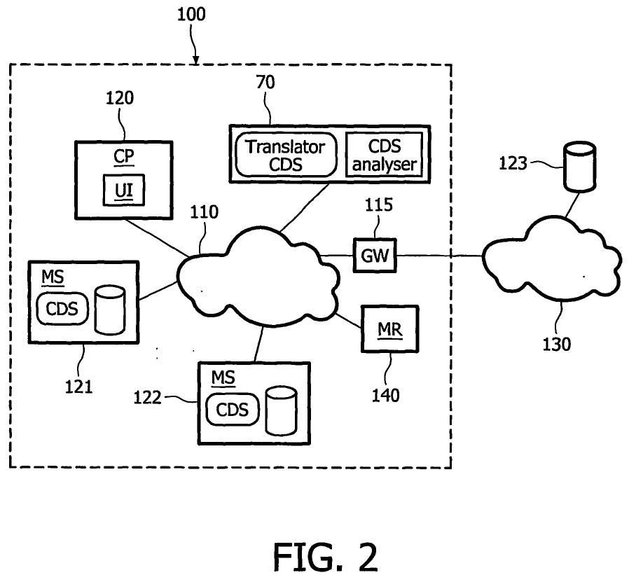

FIG. 2 shows a network of UPnP devices;

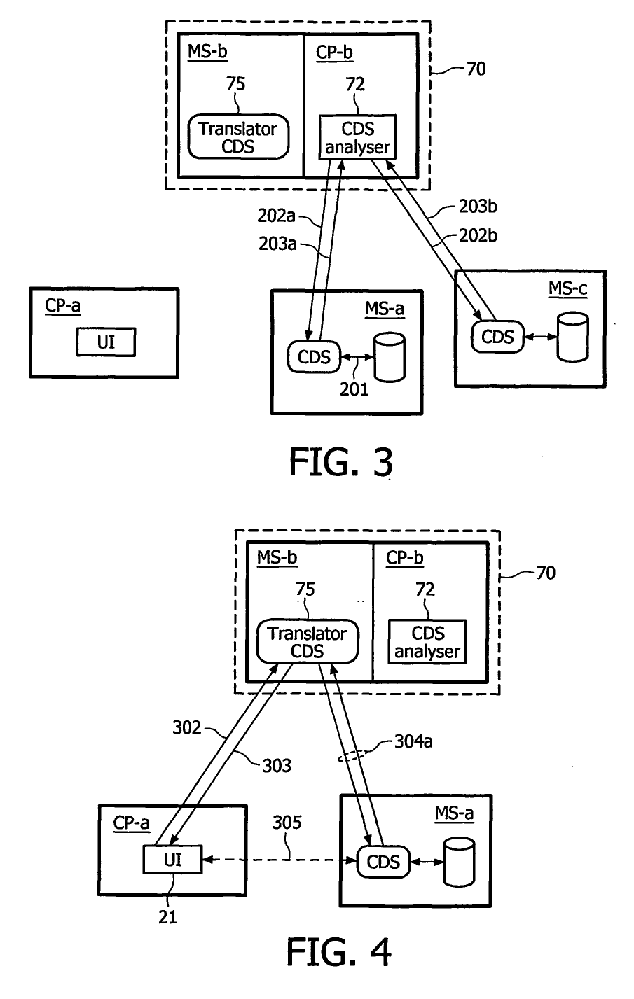

FIGS. 3 and 4 show a first embodiment of a system which includes a translator CDS function in accordance with the invention;

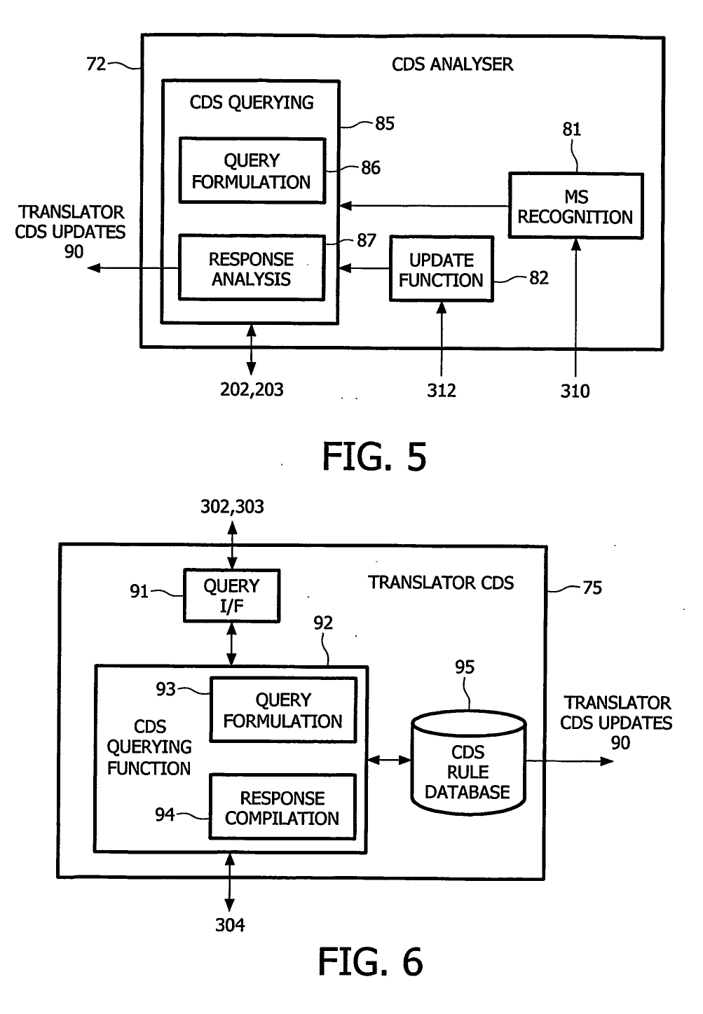

FIG. 5 shows the main functional blocks of a CDS analyser;

FIG. 6 shows the main functional blocks of a translator CDS;

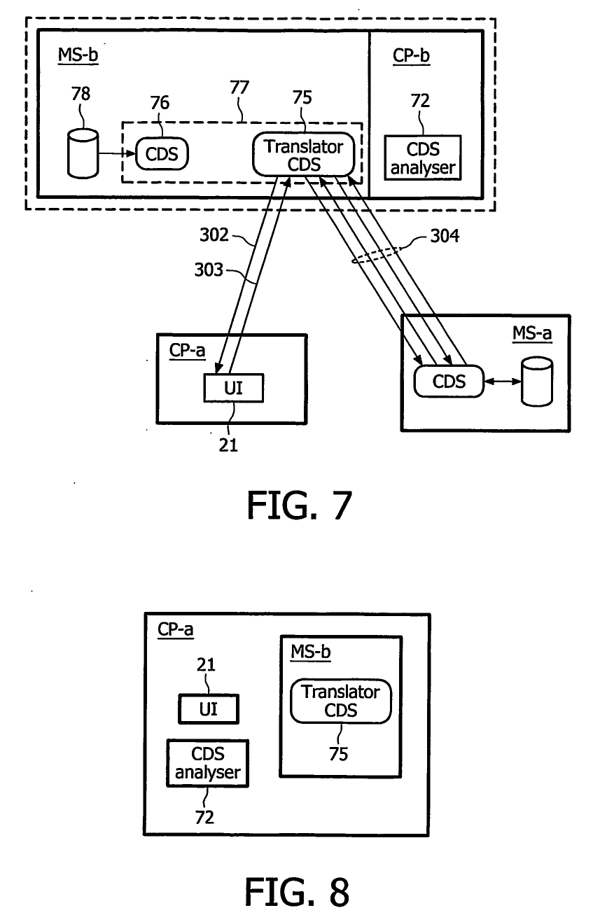

FIGS. 7 and 8 show further embodiments of a system in accordance with the invention;

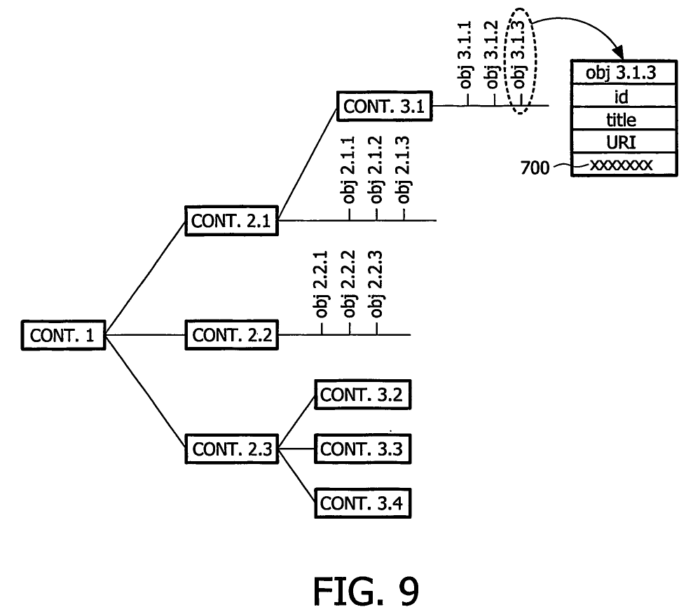

FIG. 9 shows an example structure of a CDS.

Before describing the invention in detail, a conventional UPnP system will be briefly described. A more thorough explanation can be obtained from “UPnP AV Architecture” published by the UPnP Forum. The main components of a UPnP AV system are a Control Point (CP) 20, a Media Server (MS) 50 and a Media Renderer (MR) 60. All of these are logical entities: a physical device may include only one of these entities (e.g. a Control Point in the form of a remote control) or, more commonly, a combination of several of these entities. As an example, a CD player comprises a user interface and control circuitry for operating the player (a Control Point), apparatus for reading digital content from an optical disk (a Media Server) and apparatus for converting the digital content into an audio signal for presentation to a user (a Media Renderer).

Media Server (MS) 50 includes a store 52 of media content. The content can include audio, video, still images or a combination of these. The Media Server also supports a Content Directory Service (CDS) 55 which catalogues the content in store 52. The CDS is hierarchically organised in a manner similar to a computer file system. A container (analogous to a folder or directory) can include a plurality of objects (analogous to a file) and containers that are hierarchically one level lower. The object includes an object description with an identifier and optionally metadata. The metadata may include properties such as object name, artist, composer, date created, size, etc. The object may also include the object content (item) or include a locator, such as a URL, for locating the content. An example CDS structure is shown in FIG. 9. Further functions of the Media Server 50 are a Connection Manager Service which is used to manage connections between the Media Server 50 and other devices, such as the Media Renderer 60. An optional AV Transport Service allows control of the playback of content, with features such as stop, pause, seek etc.

Media Renderer (MR) 60 is responsible for rendering (reproducing) media content which is received from a Media Server 50. Reproduction equipment 62 is shown with a display 63 and speaker 64 although the output can take many forms. Typically, the reproduction equipment 62 includes one or more decoders, digital to analog converter and amplifiers. The Media Renderer 60 also supports a Connection Manager Service 65 for establishing a new connection with a Media Server and Render Control 61 for controlling the way in which the content is rendered. For audio reproduction this can include features such as a volume control.

Control Point (CP) 20 coordinates operation of the Media Server 50 and Media Renderer 60 and includes a user interface (UI) 21 by which a user can select content. The Control Point 20 supports the conventional UPnP mechanisms for discovering new devices and also supports mechanisms for finding the capabilities of Media Rendering devices and establishing connections between a Media Server and a Media Renderer. The UPnP AV Architecture supports a wide variety of AV devices such as TVs, VCRs, CD/DVD players/jukeboxes, set-top boxes, stereo systems, MP3 players, still-image cameras, camcorders, electronic picture frames (EPFs), and the PC. The AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.).

Multiple physical devices, each having one or more or the CP, MS and MR entities, can be operated together as a network. FIG. 2 shows an example of a UPnP network which can represent a network of devices within a home. A Control Point 120, two Media Server devices 121, 122 and a Media Renderer device 140 are networked 110 together. The network 110 can be wired (e.g. Ethernet) or wireless (e.g. IEEE 802.11, Bluetooth). The media content can be wholly located on servers within the home network 100 or it can be located outside the home network 100. FIG. 2 shows a server 123 for storing content which is part of an external network 130, such as the Internet. This external server 123 is connected to the home network via a gateway 115.

Referring again to FIG. 1, this shows a conventional arrangement for accessing content over a UPnP network. The Media Server MS 50 maintains a Content Directory Service (CDS) 55 by interaction 31 with the local storage device 52. The Media Server 50 structures the COS in a particular way, which may be dictated by the manufacturer of the MS. The CDS is updated as new content is added to the store 52. At some later time, a user interacts with user interface 21. Typically, the user interface 21 will present the user with a menu of possible options. As an example, an initial menu screen may ask the user whether they wish to retrieve an audio, video or image. In response to user selections at UI 22, the CP makes an appropriate query 32 of the CDS 55 of the MS 50. MS 50 responds with the required listing of content. When the user selects a piece of content, the CP instructs the MS and the MR to arrange an appropriate connection 33, 34 and to begin streaming the content 35 from the MS to the MR.

Referring again to FIG. 2, the network also includes an entity 70 which provides a translation service for queries. Entity 70 provides the service to any devices within the network which require the translation service. In the context of a UPnP system, entity 70 is a combination of two device types: a Media Server and a Control Point as will be described later.

FIGS. 3 and 4 illustrate the operation of a first embodiment of a system in accordance with the invention. For clarity, the Figure only shows one Control Point CP-a, two Media Servers MS-a, MS-c and entity 70 hosting the translation service. The two main parts of entity 70 are a CDS analyser 72 and a translator CDS 75. CDS analyser 72 analyses the structure and capabilities of the CDS provided by one or more storage devices on the network. The results of this analysing operation set the behavioural parameters of the translator CDS 75. Translator CDS 75 provides a translation service to any Control Point (CP) devices on the network which request it. Although the translator CDS 75 appears to other UPnP devices on the network as a CDS, it does not store any media content information itself. Rather, the translator CDS 75 stores a set of behavioural parameters which allow the translator CDS to make an optimised query of an actual CDS.

As shown in FIG. 3, MS-a maintains an up-to-date CDS by interaction 201 with it's local storage, adding entries in the CDS when new objects are stored and deleting objects from the CDS when objects are removed. When Media Server device MS-a joins the network, CDS analyser 72 performs a series of queries 202a on the CDS of MS-a. These queries establish the structure and capabilities of the CDS provided by MS-a. CDS analyzer 72 analyses various features of the CDS hosted by MS-a. These can include:

the structure of the CDS, i.e. what kind of hierarchical structure of containers and objects the CDS uses and how the containers are labelled and arranged;

which standard types of object the CDS uses, and which it does not, i.e. how specific the CDS's classification of different objects is;

scope, i.e. the size of the CDS and an indication of the population sizes of particular containers or sub-sets of the CDS;

metadata availability, i.e. what metadata is included at different levels in the CDS hierarchy, and to what extent the metadata coverage is complete and consistent;

content distribution, i.e. how content of a particular type is distributed within the CDS hierarchy;

search facilities, i.e. whether the CDS supports queries of the ‘search’ type of just queries of the ‘browse’ type and also whether ‘searchable’ is switched on for containers; and,

querying performance, i.e. indications of the likely response times for standard types of query.

The CDS analyser 72 can include a standard set of queries which can be used to interrogate any unknown CDS, to derive the above information as quickly as possible. Alternatively, or additionally, the responses to initial queries are used to modify subsequent queries.

Several example scenarios now follow. In a first example, the CDS analyser 72 discovers that a particular CDS does not maintain a central list of artists for music items, but notes that artist containers are always contained within containers representing different genres of music. In response to this, the CDS analyser 72 generates a rule which states that in order to compile a list of all artists, it must aggregate the direct children of all genre containers within the CDS.

In a second example the CDS analyser 72 discovers that a particular CDS classifies all audio-only content as of generic type “audioItem”, rather than specifically as “musicTrack”, “audioBroadcast” or “audioBook”. In response to this, the CDS analyser 72 generates a rule which states that: in order to present a list of music tracks, it must search for objects of type “audioItem” and examine the metadata of each individual item to determine it's relevance.

In a third example the CDS analyser 72 discovers that the container with ID ‘53’ is the container for the genre “rock” and that this container has “searchable” switched on. A rule is created such that when any query is received to search for the genre “rock” this is translated into a search directly on container 53. In all of these examples the new rule is added to the translator CDS 75.

From the analysis performed by CDS analyser 72, a set of behavioural parameters are created. These include querying formats and strategies most appropriate for extracting information from that CDS.

CDS analyser 72 can interrogate multiple MS devices MS-a, MS-c, each having a CDS. It is likely that each CDS will have a different format, dictated by the manufacturer of the device or the user. In view of the different structures, the set of behavioural parameters derived by CDS analyser 72 will differ for each CDS.

FIG. 4 shows the operation of the translator CDS 75. In use, a user interacts with the user interface (UI) 21 of CP-a. In response to a user selection, generates a query to retrieve a list of content from a device. Instead of CP-a itself making the query, CP-a sends the query 302 to the translator CDS 75. The query includes the identity of the host MS device. The translator CDS 75 receives query 302 and consults the set of behavioural information for the host MS device. It then generates an optmised query 304a on the CDS of MS-a. Translator CDS 75 receives responses from the CDS of MS-a. According to the response, the translator CDS 75 may generate further queries. Translator CDS 75 compiles the responses into a single response 303 which is sent to CP-a and used to display a result on the UI 21. The translator CDS 75 neither stores actual media content nor content-specific information (metadata) but generates queries optimized for the MS hosting the CDS based on information about that MS.

Translator CDS 75 can receive queries from Control Points other than CP-a, each query being processed in the same manner as just described.

Entity 70 is shown according to standard UPnP conventions. In a UPnP network, control tasks are performed by a UPnP Control Point and thus the CDS analyser 72 is hosted by a Control Point device CP-b. A CDS must form part of a Media Server device, and thus the translator CDS 75 is hosted by a Media Server device MS-b. Also, to be strictly correct under UPnP conventions, querying functions can only be performed by a CP device so translator CDS 75 needs to be part of, or cooperate with, a Control Point.

CDS analyser 72 and translator CDS 75 can be housed by physically separate devices. However, the translator CDS needs to send ifs optimised queries to other CDSs, which is something that only CP devices, rather than MS devices can do. This means that the translator CDS 75 still requires access to some form of CP, such as an embedded CP, even if it is separated from the CDS analyser 72. Preferably, entity 70 is one physical device which either exists just to provide this service or, more likely, to provide this service in combination with other tasks (as shown later.)

The conventional process by which a CP arranges transfer of a selected item of content from a MS to a MR is unaffected by the provision of the translation service.

FIG. 5 shows the CDS analyser 72 in more detail, showing the main functional blocks. A CDS querying unit 85 includes a unit 86 which is responsible for formulating queries, in the manner previously described. Responses are analysed by a response analysis unit 87 which produces update messages (e.g. behaviour rules or seftings) 90 for storage by the translator CDS 75. A MS recognition function 81 recognises when new MS devices appear on the network. A standard part of the UPnP protocol is a discovery process where new devices broadcast their existence to other devices on the network. MS recognition function 81 can be arranged to receive such messages 310 and pass the identity of the new device to the CDS querying unit 85 to cause unit 85 to begin querying the new device on the network. The querying can begin immediately or after a short period to allow the new device to ‘settle in’.

In operation, the CDS analyser 72 continues to query CDSs as a background operation to ensure that the information stored in the translator CDS is as accurate as possible. A MS may notify the CDS analyser 72 by sending a message 312 whenever an update is made to it's CDS. The notification may simply indicate that a change has been made somewhere in the CDS or it may more helpfully indicate what change has been made (e.g. item “X” has been added to container “Y”). In the event that the MS does not notify the CP whenever an update is made, update function 82 can be arranged to cause the CDS analyser 72 to periodically poll the MS to check whether an update has occurred to the CDS. Update function 82 can be a timer set to a suitable value. It is not necessary for every change to be inspected by the CDS analyser 72 as most updates to a CDS will be simple operations to add new items rather than changes to the structure or mode of operation of the CDS. A small set of very specific probe queries can be run at a convenient time, such as overnight, to confirm the validity of the current analysis.

FIG. 6 shows the translator CDS 75 in more detail, showing the main functional blocks. An interface 91 receives queries 302 from Control Points and sends responses 303. The queries include requests for media information and identities of one or more MS devices hosting a CDS. A CDS querying function 92 includes a unit 93 for formulating suitable queries for sending to the identified MS devices. Function 93 uses information from database 95 to formulate optimised queries. As a simple example, database 95 may indicate that a particular CDS does not support the search function. Upon receipt of a query in the ‘search’ format, formulation unit 93 issues an optimised query which uses the browse function. In another example, database 95 indicates that a particular CDS has a container holding audio items called ‘Music’, which supports searching. As a consequence, when the query formulation unit 93 receives a request for an audio item with a particular name, it issues an optimised query in the form of a search which specifies the container ‘Music’ and the name of the requested item. A response compilation unit 94 compiles a response for sending to the CP which sent the query.

In a general case, translator CDS 75 provides a translation service for any CP that requests it, the translation service making use of the stored information about each CDS to translate a received query into one that is better suited to the known structure or capabilities of the CDS. In a further development, translator CDS 75 can also store information, in store 95, about the specific browsing, searching and retrieval tasks likely to be required by a particular CP. This allows the translator CDS to provide an improved service to each CP. By monitoring received queries from a CP, the translator CDS 75 can discover what queries are most common, and hence what rules are most relevant. This information can be sent to the CDS analyser 72 to optimise the CDS analysis procedure, concentrating on characterising the most relevant features for a particular CP. Also, the internal structure of store 95 can be optimised to provide the fastest support to the most common queries received from unit 93.

FIG. 7 shows a further embodiment of the invention with functionality similar to that shown in FIGS. 3 and 4. However, the translator CDS 75 is operated by a “friendly” Media Server, as a replacement or augmentation to it's own CDS 76. The original CDS 76 and translator CDS 75 effectively exist together as a combined CDS 77.

FIG. 8 shows a further embodiment of the invention which has similar function to the arrangements shown in FIGS. 3, 4 and 7. However, unlike those arrangements, FIG. 8 shows a CDS analyser 72 and translator CDS 75 hosted by the Control Point which hosts the user interface. The translator CDS 75 can be entirely internal to the host device, and only for use by the host device, or it can be accessible by other CPs by exposing the translator CDS 75 via an embedded Media Server device.

It will be appreciated that the provision of a CDS analyser 72 and translator CDS 75 which can be accessed by other devices allows devices with limited resource, such as portable, battery powered devices with limited processing power, to provide an improved quality of service to users. Referring again to FIG. 4, it is also beneficial where the communication link 302, 303 between the device 70 hosting the translator CDS and the CDS is of better quality than the communication link 305 between the CP hosting the UI and the CDS.

For completeness, FIG. 9 shows an example structure of a Content Directory Service (CDS) of a MS. The CDS has a hierarchical structure of containers and objects. Containers hold multiple objects, e.g. a music album is a container holding multiple audio objects. As illustrated, containers can hold further sets of containers (as with container 2.3 holding containers 3.2, 3.3, 3.4) or multiple items. Each object is defined by a number of properties. One such object, Object 3.1.3, is shown in more detail. In UPnP the properties must include an identifier such as an ‘id’ and ‘title’ (name). The object can include a Uniform Resource Identifier (URI) which points to the location of the media object. The actual content may be stored in the storage device within the Media Server (e.g. store 52 in FIG. 1) or in a server externally of the Media Server. A property of a container is a field which indicates whether the container can be searched. Further properties, including metadata 700, can also be included in the information.

1. A method of providing media content information in a system which uses a Content Directory Service (CDS) to store the media content information, comprising:
receiving, from a querying device, a query for media content information from the CDS of a serving device;
using knowledge of the CDS of the serving device, which has been previously acquired, to translate the query into an optimised query;
querying the CDS of the serving device using the optimised query; and,
providing a response to the querying device.

2. A method according to claim 1 wherein knowledge of the CDS is acquired by querying the CDS of the serving device.

3. A method according to claim 2 wherein knowledge of the CDS is acquired by querying the CDS of the serving device using a set of predetermined queries.

4. A method according to claim 2 wherein knowledge of the CDS is acquired by querying the CDS using queries received from the querying device and analysing responses received from the serving device.

5. A method according to claim 1 wherein the knowledge of the CDS comprises one or more of the following properties of the CDS: structure, scope, object typing, classification, metadata availability, content distribution, search facilities and querying performance.

6. A method according to claim 1 wherein knowledge of the CDS of a serving device is acquired when a serving device joins the system.

7. A method according to claim 1 further comprising updating knowledge of the CDS when an update occurs to the CDS.

8. A method according to claim 7 further comprising updating knowledge of the CDS in response to receiving a notification from a CDS that an update has occurred.

9. A method according to claim 1 further comprising validating the knowledge of the CDS on a periodic basis.

10. A method according to claim 1 wherein the step of translating the query into an optimised query converts a query specifying a search operation into an optimised query specifying a browse operation where the knowledge of the CDS indicates that searching is not supported.

11. A method according to claim 1 wherein knowledge of a plurality of different CDSs, each corresponding to a different serving device, is acquired.

12. A method according to claim 1 further comprising using knowledge of the querying devices.

13. A method according to claim 1 wherein the querying device is physically separate from the device which implements the method and the method is provided as a service to querying devices in the system.

14. Software for causing a processor to perform the method according to claim 1.

15. Apparatus for providing media content information in a system which uses a Content Directory Service (CDS) to store the media content information, comprising:
means for receiving, from a querying device, a query for media content information from the CDS of a serving device;
means for using knowledge of the CDS of the serving device, which has been previously acquired, to translate the query into an optimised query;
means for querying the CDS of the storage device using the optimised query; and,
means for providing a response to the querying device.

16. Apparatus according to claim 15 further comprising means for acquiring knowledge of the CDS by querying the CDS of the serving device.

17. Apparatus according to claim 16 wherein the means for acquiring knowledge of the CDS is arranged to query the CDS of the serving device using a set of predetermined queries.

18. Apparatus according to claim 16 wherein the means for acquiring knowledge of the CDS is arranged to query the CDS using queries received from the querying device and to analyse responses received from the serving device.

19. Apparatus according to claim 15 wherein the knowledge of the CDS comprises one or more of the following properties of the CDS: structure, scope, object typing, classification, metadata availability, content distribution, search facilities and querying performance.

20. Apparatus according to claim 15 which is arranged to acquire knowledge of the CDS when the serving device joins the system.

21. Apparatus according to claim 15 which is arranged to update knowledge of the CDS when an update occurs to the CDS.

22. Apparatus according to claim 15 which is arranged to validate the knowledge of the CDS on a periodic basis.

23. Apparatus according to claim 15 wherein the means for using the knowledge of the CDS is arranged to translate a query specifying a search operation into an optimised query specifying a browse operation where the knowledge of the CDS indicates that searching is not supported.

24. Apparatus according to claim 15 wherein the knowledge comprises knowledge of a plurality of different CDSs, each corresponding to a different serving device.

25. Apparatus according to claim 15 which is physically separate from the querying device.

26. An apparatus according to claim 15 wherein the system is a Universal Plug and Play (UPnP) system.
